(19) United States
(12) Patent Application Publication
(10) Pub. No.: US 2008/0093324 A1
(43) Pub. Date: Apr. 24, 2008

(54) Container for product with Better Stability

(75) Inventors: Cyrille Durand, Vittel (FR); Sandrine Damon, Vittel (FR); Martial Cinello, Hareville/Monfort (FR); Nicolas Deluce, Meudon la Foret (FR)

Correspondence Address: BELL, BOYD & LLOYD LLP, P.O. Box 1135, CHICAGO, IL, 60690, US

(73) Assignee: NESTLE WATERS MANAGEMENT & TECHNOLOGY, Issy-les-Moulineaux (FR)

(21) Appl. No.: 11/813,304

(22) PCT Filed: Dec. 21, 2005
(86) PCT No.: PCT/EP05/13768

§ 371 Date: Jul. 3, 2007

(30) Foreign Application Priority Data
Jan. 4, 2005 (EP) 05000054.6

(51) Int. Cl. B65D 1/02; B29C 49/08; B65D 23/00

(52) U.S. Cl. 215/40; 215/200; 215/375; 264/532; 53/396

(57) ABSTRACT

The invention concerns a container comprising a body formed by walls (2) and a bottom (3) having in his greater section a dimension d₁ and a neck with an internal diameter d2, said container being made from a semi-crystalline PET, the body of said container comprising at its bottom at least three feet (5) spaced from each other and being integral with said body, wherein each foot (5) is joined to the other through a flat surface (10) or a continuous line to make a contact with the support surface of said container.

The present invention relates to the field of the packaging of flowable products such as liquids or pasty products, particularly that of containers intended to contain beverages and more especially mineral water.

One topic in the packaging area, especially for water is to have a good stability of the packaging during conveying on the production line. This problem is particularly acute when the packaging arrives at the end of the line, wherein it is no more retained by its neck. In this case, the stability is really based on the bottom stability, that is on the contact between the bottom and the conveyor belt.

The objective of the present invention is to have a container for a flowable product with a bottom allowing said container to stand safely on the production line and having good mechanical properties.

The subject of the present invention is a container comprising a body formed by walls and a bottom having in his greater section a dimension d₁ and a neck with an internal diameter d₂, said container being made from a semi-crystalline PET, Polypropylene or PEN (Polyethylene naphthalate) the body of said container comprising at its bottom at least three feet spaced from each other and being integral with said body, wherein each foot is joined to the other through a flat surface or a continuous line to make a contact with the support surface of said container.

According to one embodiment, the container according to the invention has a bottom, wherein the ratio of the flat surface to the whole projected bottom surface is comprised between 10 and 60%. According to a preferred embodiment, the ratio of the flat surface to the whole projected bottom surface is comprised between 20 and 40%. In the case of a continuous line, said continuous line is the contact with the support surface of said container. This continuous line can be potentially interrupted by some engravings.

Semi-crystalline PET means in the present specification a PET having a crystallinity comprised between 10 and 60%. More preferably, the crystallinity is comprised between 20 and 40%.

One specificity of the invention is that the container has feet at the bottom, which are integral with said body. The presence of three feet is a good solution, but a presence of 4 or 5 feet is preferred for the enhancement of the stability. The geometry of said feet is not critical. Preferably, these feet have a spherical geometry.

It is possible for the container of the invention, either to have a neck with a small height, like a couple of millimeters, or to have a neck with a greater height. In this case, the ratio height of the neck on the height of the body is comprised between 1:1 and 1:4. This allows for the consumer a better gripping of said container.

Preferably, the walls of the body have a thickness of 70 to 300 μm. Each foot of the bottom of the body has a thickness comprised between 100 and 700 μm. More preferably, the thickness of the bottom is comprised between 200 and 300 μm.

The present invention concerns further a packaging assembly comprising

a container comprising a body formed by walls having in his greater section a dimension d₁ and a neck with an internal diameter d₂, said container being made from a semi-crystalline PET, PEN, PP, the body of said container comprising at its bottom at least three feet spaced from each other and being integral with said body, wherein each foot is joined to the other through a flat surface or a continuous line to make a contact with the support surface of said container.

a product in the container and

closing means for closing off or distributing the product from the neck.

The volume of the container used according to the invention can have all type of capacity, comprised between 5 cl and 20 l capacity. The container is intended to contain all type of product, like pasty, liquid, semi-liquid, granular or powdered product. Under liquid product, we understand water or a still liquid beverage, particularly still mineral waters, carbonated water or a carbonated liquid beverage, particularly sparkling mineral water. Other types of liquid products are also possible, like chemical products, oil, essence, perfumes, pharmaceutical products. Under pasty products, we understand food and non food products, like mayonnaise, cosmetic compounds and others.

The means of closing are either a cap, or sealed membrane. The caps can be used for any diameter of opening of the neck. On the contrary, the sealed membranes are preferred with smaller diameter of the neck, for example in the area of 10 mm. In this case, the container can support high compressions, for example by the storage and by the transportation. For diameters of around 10 mm, the container can support an internal pressure of the order of 5 bar. It is also possible to close the container by sealing or welding the neck, wherein a cutting object or similar is provided for the opening.

As a preference, the container has an ovoid or substantially ovoid overall shape. This natural shape derived from an egg represents a structure whose resistance to vertical and/or transversal loads is optimized, thus making it possible, for a given volume and a given amount of material, to achieve mechanical properties which are equivalent to or even better than the cylindrical or roughly cylindrical shapes customarily encountered in this domain.

In another embodiment, the container according to the invention has a three dimensional shape convenient for gripping, a spherical, substantially spherical or cylindrical overall shape.

This is because the geometry with symmetry of revolution is particularly easy and therefore economical to manufacture and has the advantage of allowing the container to be filled with products which can emit gaseous substances, such as carbonated beverages (sparkling waters, sodas, etc.) in particular, which are widely consumed worldwide these days. Such a shape is therefore particularly well suited to these liquids in that the release of carbon dioxide or other gas has a tendency to deform the bodies of bottles which do not have symmetry of revolution, having a negative impact on their stability, grasp and ease of handling, appearance, etc.

In a preferred feature of the invention, the ratio d2 on d1 of the container is comprised between 1:3 and 1:10. According to a preferred embodiment of the packaging assembly, the ratio weight of the walls on weight of the bottom is comprised between 2 and 4.

Under bottom in the present description, we understand all the part of the body comprising the space of said body inside the feet, said feet being taken from their most external position. Under body, we understand the container without the neck.

According to another feature, the plastic used to form the wall or walls is a semicrystalline plastic with a slow rate of crystallization, the glass transition temperature (T_{g}) of which is 70° C. or higher and the crystallisation temperature Tc is around 140° C. A slow rate of crystallization is to be understood as meaning a rate which makes it possible to have an amorphous state by quick cooling.

Advantageously, the plastic used to form the wall or walls is chosen from the group formed by PET (polyethylene terephthalate), PEN (polyethylene naphthalate) or Polypropylene (PP). It has been noted that the drawing of the PET has no negative influence on the water barrier properties of the obtained container and that also a thickness of around 100-300 μm guarantees a good safety of the container itself and of the storage.

In order to guarantee both the flexibility needed for the aforementioned deformation and sufficient mechanical strength, the container according to the invention is further characterized in that the thickness of the wall or walls forming the body of the container is between 70 μm and 300 μm, preferably between 150 μm and 200 μm. As already mentioned, small thicker areas or portions of walls may also be provided on the body of the said container, particularly in close proximity to the neck and/or the bottom, so as to reinforce these parts locally. Such reinforcements may in particular be useful to facilitate the filling of the said containers or to increase their stability during storage.

As a preference, the container is further characterized in that the body and the neck of the container are made as a single piece. This makes it possible to avoid any join or weld which may constitute a region of greater weakness.

These simple shapes also allow the container according to the invention to be used as a refill or recharge for water coolers, for which a flat bottom is not necessary, these refills generally being used by inserting the container, head (neck) downmost, into the accommodation device of the said water cooler. In addition, this type of surface geometry also makes it possible to increase the area of heat exchange between the said container and the chilling device usually present in the said water coolers.

According to another alternative form, the container according to the invention is characterized in that the neck is fitted with a closure and/or distribution means produced in the form of a distribution tap which can be operated with one hand.

Such distribution taps, which are known per se, advantageously allow the distribution of the flowable product contained in the container to be regulated in a particularly convenient way, for example when this container is stored horizontally on the shelves of a refrigerator, the other hand holding the container into which the said flowable product is to be transferred, for example with a view to consuming it.

Another subject of the present invention is the use of the container by way of large-capacity, at least 5-litre capacity, container intended to contain water or a still liquid beverage, particularly still mineral water. Another subject of the present invention is the use of the container according to the invention by way of large-capacity, at least 5-litre capacity, container intended to contain carbonated water or a carbonated liquid beverage, particularly sparkling mineral water. Of course, the containers of the present invention are not in any way limited to flat or sparkling mineral waters but can be intended to contain all sorts of flowable products, edible or inedible liquids of greater or lesser fluidity such as, for example, fruit juices, milk-based beverages, etc., and also sauces or condiments (ketchup, mustard, dressing, etc.) or non-food liquids (deionized water, cleaning products, detergents, etc.).

The packaging assembly according to the invention can also contain a functional component. The functional component is taken from the group consisting of a fibre, plant extract, fruit extracts, vitamins and flavors. The assembly is pasteurised or sterilised at a temperature in excess of 60° C.

The packaging assembly according to the invention has walls comprising a moulded shape. The shape can be any type of shape, pleasant for kids, like human faces, or animals or any other non living objects. Each assembly can also have a different moulded shape in the wall. It is also possible according to the invention to have a multipack with a plurality of assemblies having different moulded shapes in the walls.

According to another feature, the packaging assembly according to the invention, presents the moulded shape, which is totally or partially hidden by the label.

According to another feature, packaging assembly according to the invention has walls, which are colourable.

Finally, another subject of the present invention is a method for manufacturing a body of a container according to the invention, characterized in that the said body is obtained by stretch blow forming of a PET, PEN or PP preform with different moulds, which are in the same set of moulds. This means that the machine, for example, comprises 6 or more different moulds, forming then different shapes. The blow forming can be also a blow molding. Compared with the blowing of plastic bottles, wherein the blowing pressure is comprised between 30 and 40 bar, according to the process of the invention, it is sufficient to blow at a pressure of around 2 times less. This reduces the cost of the process and also of the machine which is used.

The measure of the crystallinity is made on a density column from Lloyd-Davenport, according to following procedure. The column is filled with a salted solution (calcium nitrate) having a density gradient. The column is calibrated with balls having known density between 1.335 and 1.455. Then small pieces of the container of the invention are immerged in the column and after a certain time, they stay at a certain height of the column corresponding to a certain density. The measures are made at 23° C. The following correspondence table with ρ_{c} of 1.455 gives the crystallinity

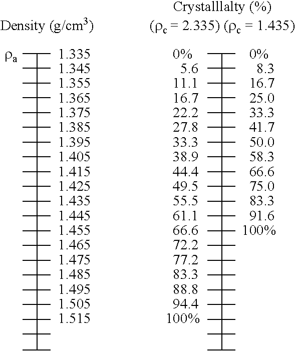

The invention concerns further a method for permitting children to transform containers into toys wherein the children have the possibility of surface colouring the walls of the container either with the full or the void container.

Finally, the invention concerns a method for enhancing the play value of the packaging assembly according to the invention, wherein the children by tearing the label discover the whole moulded shape.

Other features and advantages of the invention will become apparent from the description which follows, given by way of example and with reference to the appended drawings in which:

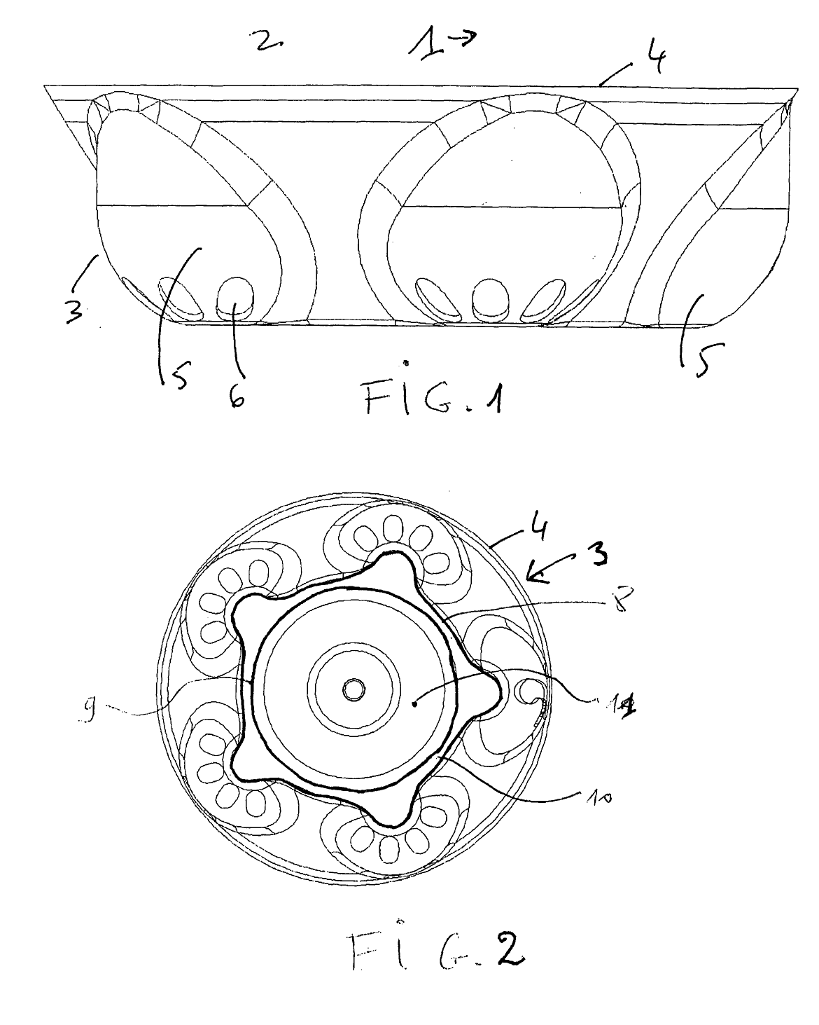

FIG. 1 is a lateral perspective view of the container according to the invention,

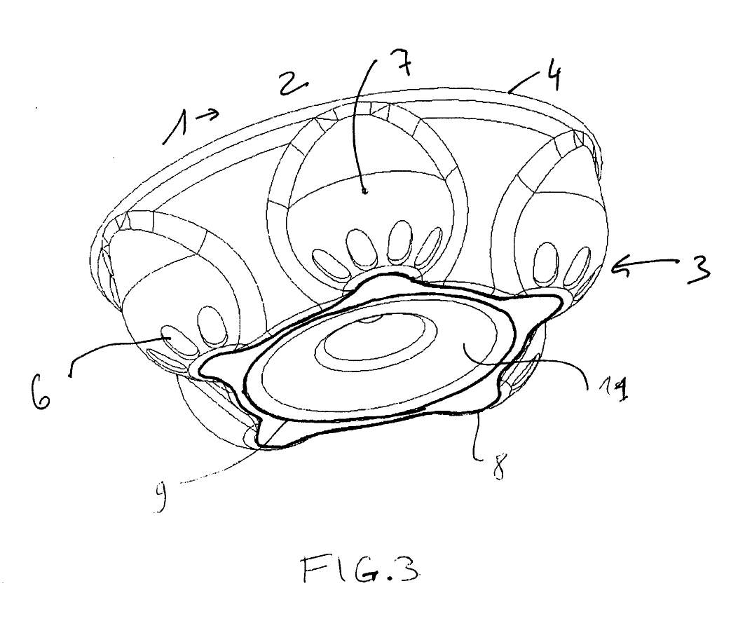

FIG. 2 is a view of the container of the invention, seen from the bottom and

FIG. 3 is a perspective view of the bottom of the container according to the invention.

In the embodiment described and depicted on FIGS. 1, 2 and 3, the container for a flowable product, particularly for a beverage and, in particular, for mineral water, essentially consists of a body 1 having in his greater section a dimension d1 (not shown), formed by walls 2 and a bottom 3 and a neck with an internal diameter d2 (not shown). The body is made of a semi-crystalline PET. The bottom 3 presents five feet 5 integral with the body. The feet 5 present engravings 6, which have only a decorative function. The volume of the container is of 330 ml. In this specific example the ratio weight of the walls on weight of the bottom is of 2.5. The thickness of the walls is around 250 μm. In the area 7 of the feet, that means around the middle of said feet, the wall thickness is also around 600 μm. The feet have a semi-spherical shape. Concerning now the limits of the wall and bottom for calculating the ratio weight of the walls on weight of the bottom, it is outside and inside of the circle 4 of the figures.

The feature of the invention is that each foot 5 is joined to the other foot through a flat surface 10 to make a contact with the support surface of said container. The whole contact surface is delimited between the two circles 8 and 9. The central part 11 of the bottom will not be in contact with the support surface of the container. In this specific case, the ratio flat surface to the whole projected bottom surface is of 30%

1. A container comprising a body comprising walls and a bottom having a section having a dimension d₁ and a neck with an internal diameter d₂, the container being made from a material selected from the group consisting of a semi-crystalline PET, PP and PEN, the body of the container comprising at its bottom at least three feet spaced from each other and being integral with the body, each foot being joined to the other through a flat surface or a continuous line to make a contact with a support surface of the container.

2. A container according to claim 1, wherein the walls of the body have a thickness of 70 to 300 μm.

3. A container according to claim 1, wherein each foot has a wall thickness of between 100 and 700 μm.

4. A container according to claim 1, wherein the ratio of the flat surface to an entire projected bottom surface is between 10 and 60%.

5. A container according to claim 4, wherein the ratio of the flat surface to the entire projected bottom surface is between 20 and 40%.

6. A packaging assembly comprising
a container comprising a body formed by walls having a dimension d₁ and a neck with an internal diameter d₂, the container being made of a material selected from the group consisting of semi-crystalline PET, PEN and PP, the body of the container comprising at its bottom at least three feet spaced from each other and being integral with the body, each foot being joined to the other to make a contact with the support surface of said container
a product in the container; and
a closure.

7. A packaging assembly according to claim 6, wherein the product is selected from the group consisting of pasty, liquid, semi-liquid, granular and powdered product.

8. A container according to claim 1, wherein the body of the container has a form selected from the group consisting of a three dimensional shape convenient for gripping, an ovoid, spherical, elliptical and cylindrical shape.

9. A container according to claim 1, wherein the wall thickness of the body, substantially in the middle of its body is between 70 and 300 μm.

10. A container according to claim 1, wherein the ratio d2 on d1 is between 1:3 and 1:10.

11. A container according to claim 1, wherein the ratio height of the neck on the height of the body is between 1:1 and 1:4.

12. A container according to claim 1, wherein the ratio weight of the walls on weight of the bottom is between 2 and 4.

13. A container according to a claim 1, wherein the walls comprise a moulded shape.

14. A container according to claim 1, wherein the moulded shape is at least partially hidden by the label.

15. A container according to claim 1, wherein the walls are colourable.

16. A plurality of packaging assemblies according to claim 1, wherein each assembly has a different moulded shape in the walls and the assemblies are maintained together in a shrink film packing.

17. A process for manufacturing the packaging assemblies, each assembly comprising a container comprising a body comprising walls and a bottom having a section having a dimension d₁ and a neck with an internal diameter d₂, the container being made from a material selected from the group consisting of a semi-crystalline PET, PP and PEN, the body of the container comprising at its bottom at least three feet spaced from each other and being integral with the body, each foot being joined to the other to make a contact with a support surface of the container wherein each assembly has a different moulded shape in the walls and the assemblies are maintained together in a shrink film packing, wherein the assemblies are obtained by stretch blow forming of a PET preform with different moulds.

18. A method for permitting children to transform containers into toys comprising the steps of providing children with the ability of surface colouring the walls of the container either with the container being full or empty.

19. A method for providing a container having a play value, comprising the steps of providing a body comprising walls and a bottom having a section having a dimension d₁ and a neck with an internal diameter d₂, the container being made from a material selected from the group consisting of a semi-crystalline PET, PP and PEN, the body of the container comprising at its bottom at least three feet spaced from each other and being integral with the body, each foot being joined to the other to make a contact with a support surface of the container and providing a label that only allows a child by tearing the label to discover the entire moulded shape.
